(19) United States
(12) Patent Application Publication
(10) Pub. No.: US 2017/0355253 A1
(43) Pub. Date: Dec. 14, 2017

(54) SEALING STRUCTURE FOR AUTOMOBILE

(71) Applicant: NISHIKAWA RUBBER CO., LTD., Hiroshima-shi (JP)

(72) Inventors: Hirofumi OGAWA, Hiroshima-shi (JP); Satoshi MAESAKI, Hiroshima-shi (JP); Kayo YONEDA, Yokohama-shi (JP); Keisuke NAGAI, Zama-shi (JP); Takuya TANI, Atsugi-shi (JP)

(21) Appl. No.: 15/617,208

(22) Filed: Jun. 8, 2017

(30) Foreign Application Priority Data
Jun. 9, 2016 (JP) 2016-115291

(51) Int. Cl. B60J 10/70; F16J 15/02; E06B 7/23; B60J 10/21; B60J 10/86; B60J 10/246

(52) U.S. Cl. CPC B60J 10/70; B60J 10/86; B60J 10/246; E06B 7/2309; B60J 10/21; F16J 15/027

(57) ABSTRACT

A sealing structure for use on an automobile having a weather strip and an interior member wherein the weather strip includes an installation base member having an inner-cabin side wall, an outer-cabin side wall, a connecting wall and holding lips; and a seal member. The installation base member couples to a flange vertically formed along a peripheral edge of an opening corresponding to a door. The seal member is formed on the outer-cabin side wall and makes elastic contact with a door glass. The interior member is provided on an inner-cabin side of the inner-cabin side wall. An end of the interior member extends toward the connecting wall. A projection is formed on an outer circumference of a connecting part between the outer-cabin side wall and the connecting wall. The projection extends in an internal circumferential direction and covers the end of the interior member from an outer-cabin side.

### CROSS REFERENCE TO RELATED APPLICATION

This application claims the benefit under 35 USC §119 of JP Patent Application JP 2016-115291 filed Jun. 9, 2016, the entire disclosure of which is incorporated herein by reference.

### BACKGROUND INFORMATION

The present invention relates to sealing structures for automobiles with interior members provided on inner-cabin sides of weather strips. The weather strips are configured to operably couple to flanges vertically formed along peripheral edges of openings corresponding to doors.

FIG. 7(a) and FIG. 7(b) show an automobile with a glass hatch 2 on a back door 1. The glass hatch (door glass) 2, which is independent from the back door 1 and which is capable of opening and closing vertically by hinges 2a, 2b, is provided at a center of the back door 1. The back door 1 opens and closes vertically by hinges not shown. Accordingly, as shown in FIG. 7(b), the glass hatch 2 can be opened outward with the back door 1 closed.

As shown in FIG. 8, a weather strip 10 is provided between the back door 1 and the glass hatch 2.

The weather strip 10 includes an installation base member 11 and a hollow seal member 12. The installation base member 11 is configured to operably couple to a flange 70 vertically formed along a peripheral edge of an opening, which corresponds to the glass hatch 2, on the back door 1. The installation base member 11 has a substantially U-shaped cross section including an inner-cabin side wall 11a, an outer-cabin side wall 11b, and a connecting wall 11 c which connects the side walls. The installation base member 11 also has a plurality of holding lips 11d formed on an inner side. The hollow seal member 12 is formed on the outer-cabin side wall 11b of the installation base member 11 and is configured to make elastic contact with the glass hatch 2.

The installation base member 11 has a core 13, which has a substantially U-shaped cross section, buried therein for increasing rigidity.

In addition, an interior member 20 is provided on an inner-cabin side of the inner-cabin side wall 11a of the installation base member 11 of the weather strip 10 and an end 20a of the interior member 20 is bumped against the inner-cabin side wall 11a.

In case the end 20a of the interior member 20 deviates from a standard position, a space appears between the end 20a of the interior member 20 and the inner-cabin side wall 11a of the installation base member 11. Accordingly, on a lower part of the opening corresponding to the glass hatch 2, color of a door panel 1a on which the flange 70 is vertically formed is visible from outside. Also, the end 20a of the interior member 20, which is exposed, degrades appearance.

Further, while luggage is being taken out, the luggage may make elastic contact with and tear the hollow seal member 12.

In this connection, a configuration as shown in FIG. 9 and FIG. 10 has been known that a lip 31 covers up an end 40a of an interior member 40. The lip 31 has a substantially tongue shaped cross section and forms a part of a seaming welt 30 configured to operably couple to a flange 80 vertically formed along a center pillar of an automobile. This configuration is not for use on the back door 1 (see, Japanese unexamined Utility Model Publication No. S61-101058, for example).

In Japanese unexamined Utility Model Publication No. S61-101058, a protrusion 32 is formed on a body of the seaming welt 30 so that the end 40a of the interior member 40 makes elastic contact with the protrusion 32. As a result, the seaming welt 30 is configured to operably couple to the flange 80 depending on the position of the interior member 40. This configuration prevents waving phenomena on the lip 31 of the seaming welt 30 and improves appearance.

Unfortunately, however, the protrusion 32 is formed on a corner part of a space between the seaming welt 30 and the lip 31. Accordingly, Japanese unexamined Utility Model Publication No. S61-101058 is complicated in structure and difficult to manufacture.

Also, in the automobile of FIG. 7(a) and FIG. 7(b) with the glass hatch 2 on the back door 1, the interior member 20 may be assembled after the weather strip 10 couples to the flange 70 and is adjusted to fit right. Under the circumstance, since the end 20a of the interior member 20 is hard to arrange on the back of the lip 31 of FIG. 10, the lip 31 can not be formed on the weather strip 10.

Accordingly, an object of the present invention is to provide the sealing structures for automobiles, which prevent degradation in appearance even in case the interior members slightly deviate from standard positions.

### SUMMARY

In order to achieve the above-mentioned object, according to one aspect of the invention, a sealing structure for an automobile is provided, the automobile including a weather strip (10) and an interior member (50). The weather strip (10) includes an installation base member (11) and a seal member (12). The installation base member (11) is configured to operably couple to a flange (70) vertically formed along a peripheral edge of an opening corresponding to a door in an internal circumferential direction. The installation base member (11) has a substantially U-shaped cross section including an inner-cabin side wall (11a), an outer-cabin side wall (11b) and a connecting wall (11c) which connects the side walls and a plurality of holding lips (11d) formed on an inner side. The seal member (12) is configured to make elastic contact with a door panel or a door glass (2) and is formed on the outer-cabin side wall (11b) of the installation base member (11). The interior member (50) is provided on an inner-cabin side of the inner-cabin side wall (11a) of the installation base member (11) of the weather strip (10). An end (50a) of the interior member (50) extends toward the connecting wall (11c) of the installation base member (11) of the weather strip (10). A projection (100) (except for a lip shape having a substantially tongue shaped cross section) is formed on an outer circumference of a connecting part between the outer-cabin side wall (11b) and the connecting wall (11c) of the installation base member (11). The projection (100) extends in the internal circumferential direction and covers up the end (50a) of the interior member (50) from an outer-cabin side.

In addition, according to an aspect of the present invention, the flange (70) is vertically formed on a back door (1) which opens and closes. The back door (1) has the door glass (2) provided thereon. The door glass (2) is independent from the back door (1) and capable of opening and closing. The seal member (12) of the weather strip (10) is configured to make elastic contact with the door glass (2).

In addition, according to an aspect of the present invention, the end (50a) of the interior member (50) is bent toward a lower side from an upper side.

In addition, according to an aspect of the present invention, the projection (100) includes sponge material and the installation base member (11) includes solid (dense) material.

Symbols in parentheses show constituents or items corresponding to the drawings.

According to the present invention, exposure of the end of the interior member is prevented by the configuration that: the end of the interior member extends toward the connecting wall of the installation base member; and the projection, which extends in the internal circumferential direction of the opening corresponding to the door, is formed on the outer circumference of the connecting part between the outer-cabin side wall and connecting wall. In the configuration, the interior member is provided on the inner-cabin side of the inner-cabin side wall of the installation base member of the weather strip, the installation base member has the substantially U-shaped cross section and is configured to operably couple to the flange vertically formed along the peripheral edge of the opening corresponding to the door. Also, the projection covers up the end of the interior member from the outer-cabin side.

The projection covers up a space between the end of the interior member and the installation base member, caused by deviation in positions of the interior member, and color of the door panel is not visible from outside.

It is to be noted that the “projection” is not the lip having the substantially tongue shaped cross section as in the prior art (FIG. 10).

In other words, in the automobiles with the following features, the interior members are assembled after the weather strips couple to the flanges: the door glasses (glass hatches), which are independent from the back doors and capable of opening and closing, are provided on the back doors which open and close; and the seal members of the weather strips, which couple to the flanges vertically formed from lower parts (lower sides) of the back doors, are configured to make elastic contact with the door glasses. Since the interior members are assembled after the weather strips couple to the flanges, the lips having substantially tongue shaped cross sections as in the prior art can not be provided on the installation base members of the weather strips. But when the projection of the present invention is provided on the installation base member, the interior member may be assembled after the weather strip couples to the flange. In case the lip having the substantially tongue shaped cross section is provided on the installation base member, the lip hampers assembly of the interior member on parts and degrades appearance when the installation base member is assembled along corners having short radius of curvature, and therefore, the lip becomes unnecessary and need be cut out except for the lower part (lower side) of the back door. The projection of the present invention, which is small in size and not noticeable, need not be cut out.

In addition, the end of the interior member extends toward the connecting wall of the installation base member and the interior member can be on a position upper to the seal member on the installation base member. With this configuration, the luggage does not tear the seal member while being taken out and dragged.

In addition, the end of the interior member is bent toward the lower side from the upper side. Accordingly, the end of the interior member may be perpendicular to the connecting wall of the installation base member so that the end of the interior member makes elastic contact with the connecting wall or faces the connecting wall with a slight distance therebetween. This configuration simplifies assembly of the interior member after the weather strip couples to the flange.

In addition, the installation base member includes solid (dense) material and the projection includes sponge material. This configuration further deals with deviation in positions.

### BRIEF DESCRIPTION OF THE DRAWINGS

FIG. 1 is an enlarged sectional view of a sealing structure according to an embodiment of the present invention for an automobile taken along a line I-I of FIG. 7(b);

FIG. 2 is an enlarged sectional view of a weather strip of FIG. 1

FIG. 3 is an enlarged sectional view of an important part of the sealing structure according to the embodiment of the present invention for the automobile;

FIG. 4 is an enlarged sectional view of deviation in positions of an interior member with respect to an installation base member of the weather strip of FIG. 3;

FIG. 5 is an enlarged sectional view of an important part of another sealing structure according to the embodiment of the present invention for an automobile;

FIG. 6 is an enlarged sectional view of a sealing structure according to still another embodiment of the present invention for an automobile taken along a line VI-VI of FIG. 9;

FIG. 7(a) and FIG. 7(b) are perspective views of a rear part of an automobile with a glass hatch provided on a back door, in which the glass hatch is closed in FIG. 7(a) and the glass hatch is opened in FIG. 7(b);

FIG. 8 is an enlarged sectional view of a sealing structure of a prior art for an automobile taken along the line I-I of FIG. 7(b);

FIG. 9 is an external side view of an automobile; and

FIG. 10 is an enlarged sectional view of another sealing structure of the prior art for an automobile taken along the line VI-VI of FIG. 9.

### DETAILED DESCRIPTION

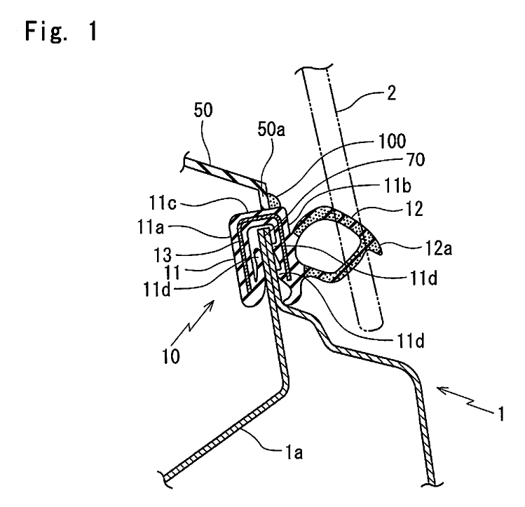

Referring to FIGS. 1, 2, 3 and 7, a sealing structure according to an embodiment of the present invention for an automobile will be described.

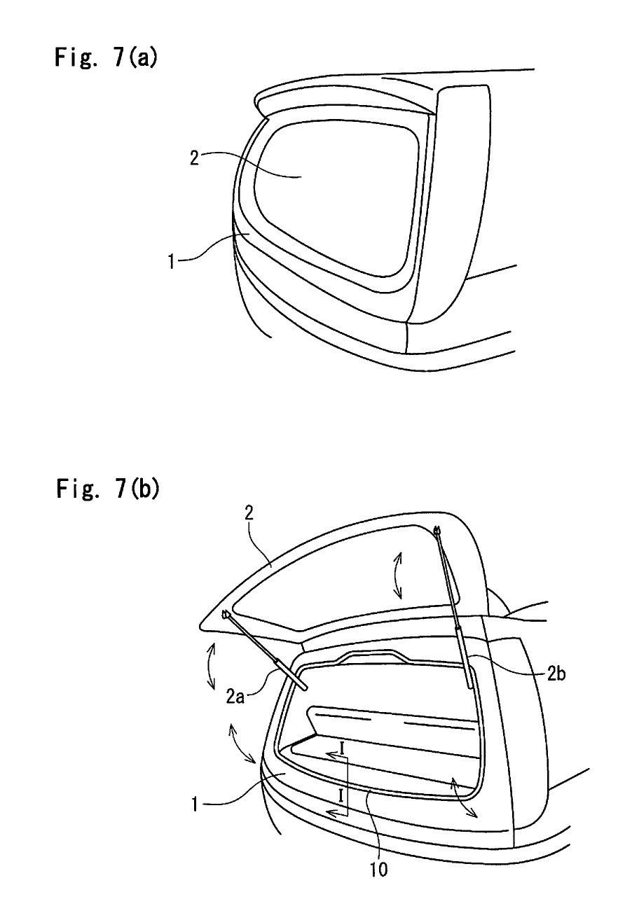

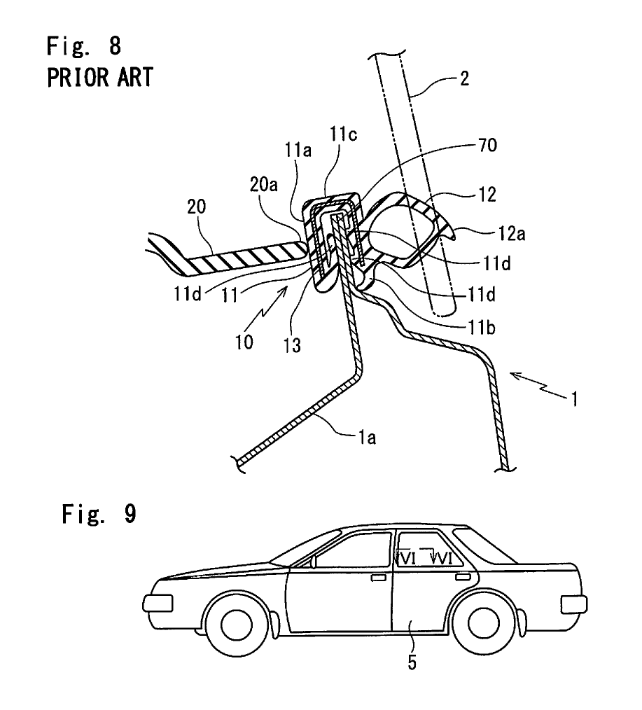

The sealing structure is for closing a space between a back door 1 and a glass hatch 2 by a weather strip 10, and is for use on an automobile with an interior member 50 provided on an inner-cabin side of the weather strip 10. As shown in FIG. 7(a) and FIG. 7(b), the glass hatch (door glass) 2, which is independent from the back door 1 and which is capable of opening and closeing vertically by hinges 2a, 2b, is provided at a center of the back door 1. The back door 1 opens and closes vertically by hinges (not shown).

As shown in FIG. 1, the weather strip 10 is configured to operably couple to a flange 70 vertically formed on the back door 1. When the glass hatch 2 is closed, the weather strip 10 makes elastic contact with a glass surface on an inner-cabin side of the glass hatch 2 and seals an inner-cabin side of the automobile from an outer-cabin side thereof.

The flange 70 is vertically formed around a whole peripheral edge of an opening corresponding to the glass hatch 2 (peripheral edge of an opening corresponding to a door) in an internal circumferential direction. As shown in FIG. 1, on a lower part (lower side) of the back door 1, which is on a lower side with respect to the glass hatch 2, the flange 70 is vertically formed in an upward direction. The interior member 50, which is provided on the lower part (lower side) of the back door 1, is for use on the back door 1 and is not provided on an upper part, a right part or a left part. As the back door 1 opens and closes, the interior member 50 as well as the weather strip 10 is pivoted.

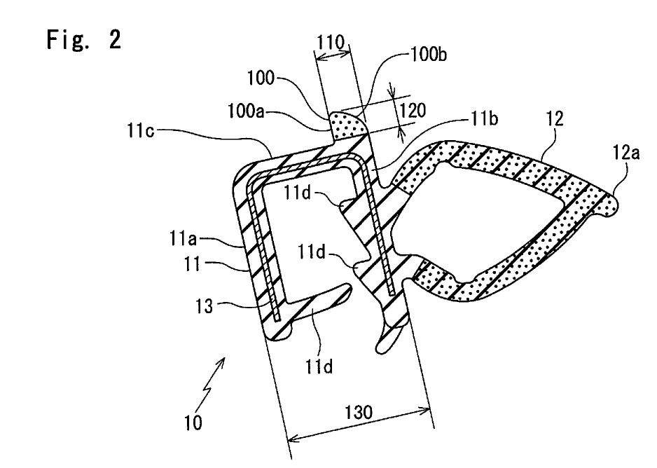

As shown in FIG. 2, the weather strip 10 includes an installation base member 11 and a hollow seal member 12.

The installation base member 11 has a substantially U-shaped cross section and includes an inner-cabin side wall 11a, an outer-cabin side wall 11b and a connecting wall 11c which connects ends of the inner-cabin side wall 11a and the outer-cabin side wall 11b. The installation base member 11 also has a plurality of holding lips 11d (in the present embodiment, one holding lip 11d1 on the inner-cabin side wall 11a and two holding lips 11d2, 11d3 on the outer-cabin side wall 11b) formed on an inner side. The installation base member 11 has a core 13, which has a substantially U-shaped cross section, buried therein for increasing rigidity.

The hollow seal member 12, of which two base roots are integrally molded with the outer-cabin side wall 11b of the installation base member 11, is curved toward an outer-cabin side. A convex 12a is formed on a top end of the hollow seal member 12 so that the hollow seal member 12 comes into contact with the glass hatch 2 from the convex 12a. But the seal member 12 may have a substantially diamond-shaped cross section or a substantially circular shaped cross section and the convex 12a may be omitted.

A projection 100 is formed on a corner on an outer-cabin side of the installation base member 11, which is on an outer circumference of a connecting part between the outer-cabin side wall 11b and the connecting wall 11c of the installation base member 11. The projection 100 extends in the internal circumferential direction from the installation base member 11 and covers up an end 50a of an interior member 50 from an outer-cabin side.

The projection 100 is a lump. In the present embodiment, the projection 100 has a substantially (¼) circular shaped cross section, of which an inner-cabin side surface 100a is flat and an outer-cabin side surface 100b is curved. Width 110 of the projection 100 in an inner-cabin and an outer-cabin direction is not less than length 120. With this configuration, when the weather strip 10 is provided around the whole peripheral edge of the opening corresponding to the glass hatch 2, the projection 100 does not fall down toward the inner-cabin side or the outer-cabin side with respect to a direction in which the projection 100 extends, and therefore, appearance is improved. The width 110 of the projection 100 is substantially a ¼ of width 130 of the installation base member 11.

Shape of the projection 100 is not limited as long as the projection 100 is not a lip having a substantially tongue shaped cross section as in the prior art (lip 31 in FIG. 10). In case the projection 100 is the lip, of which length 120 is not less than twice the width 110 in the inner-cabin and the outer-cabin direction, the lip is bendable from a base root over a top end and presses the interior member 50 against the installation base member 11. With this configuration, it is impossible or very hard to assemble the interior member 50 after the weather strip 10 couples to the flange 70. In addition, with this configuration, on positions where the lip is unnecessary, the lip need be cut out. This configuration, which is with complexity, is hardly adopted.

Material of the weather strip 10 is not specifically limited. But the weather strip 10 preferably includes rubber like elastic body, which weather strips in general are made of. Examples of the material of the weather strip 10 include: a rubber material mainly including EPDM; thermoplastic elastomer (TPE) such as olefinic thermoplastic elastomer TPO, styrene-based thermoplastic elastomer TPS. In the present embodiment, the projection 100 and the hollow seal member 12 include sponge material (foamed body) of the rubber like elastic body, and the installation base member 11 includes a solid (dense) material of the rubber like elastic body. The weather strip 10 is assembled on the flange 70 in a manner that the connecting wall 11c of the installation base member 11 faces an internal circumference of the opening corresponding to the glass hatch 2. The projection 100, which includes sponge material, simplifies and does not hamper bending of the weather strip 10 on corners.

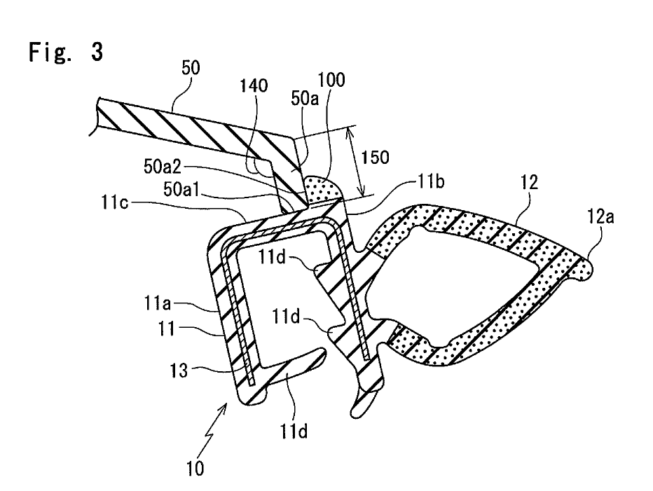

As shown in FIG. 3, the end 50a of the interior member 50 is bent toward a lower side from an upper side and extended toward the connecting wall 11c of the installation base member 11 of the weather strip 10.

More specifically, the interior member 50 is extended and gently descended toward the outer-cabin side from the inner-cabin side. The end 50a of the interior member 50 is bent at an obtuse angle 140 and is substantially perpendicular to the connecting wall 11c of the installation base member 11, in other words substantially in parallel with a direction in which the flange 70 extends, so that an end surface 50a 1 of the end 50a of the interior member 50 abuts with an outer circumferential surface of the connecting wall 11c and an outer-cabin side surface 50a 2 of the end 50a of the interior member 50 abuts with the inner-cabin side surface 100a of the projection 100.

Length 150 of the end 50a of the interior member 50 (length between a bent part and the end surface 50a1) is substantially twice as long as the length 120.

According to the sealing structure of the embodiment of the present invention for the automobile, exposure of the end of the interior member is prevented by the configuration that: the end 50a of the interior member 50 extends toward the connecting wall 11c of the installation base member 11 of the weather strip 10; and the projection 100, which is the lump, is formed on the outer circumference of the connecting part between the outer-cabin side wall 11b and the connecting wall 11c of the installation base member 11. In the configuration, the projection 100 extends in the internal circumferential direction and covers up the end 50a of the interior member 50 from the outer-cabin side.

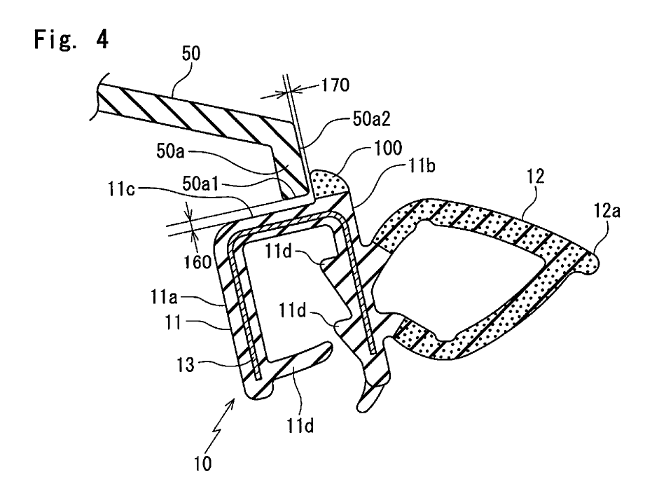

As shown in FIG. 4, deviation in positions of the interior member 50 causes spaces between the end 50a of the interior member 50 and the installation base member 11. Specifically, the spaces include: a small space 160 between the end surface 50a 1 of the end 50a of the interior member 50 and the connecting wall 11c ; and a small space 170 between the outer-cabin side surface 50a 2 of the end 50a of the interior member 50 and the inner-cabin side surface 100a of the projection 100. Since the projection 100 covers up the end 50a of the interior member 50 from the outer-cabin side, an inside of the interior member 50 (door panel 1 a, for example) is not visible from outside and appearance is improved.

In addition, even in case the end 50a of the interior member 50 presses the inner-cabin side surface 100a of the projection 100 toward the outer-cabin side, the projection 100, which includes sponge material, deals with the deviation in positions of the interior member 50 toward the outer-cabin side.

In addition, the projection 100, which is slight in the length 120 and hardly noticeable, does not degrade appearance when the weather strip 10 is provided around the whole peripheral edge of the opening.

In addition, the interior member 50 is simply assembled after the weather strip 10 couples to the flange 70. As the interior member 50 is assembled after the weather strip 10 couples to the flange 70, as shown in FIG. 4, the interior member 50 may be assembled in a manner to provide the space intentionally between the end 50a of the interior member 50 and the installation base member 11.

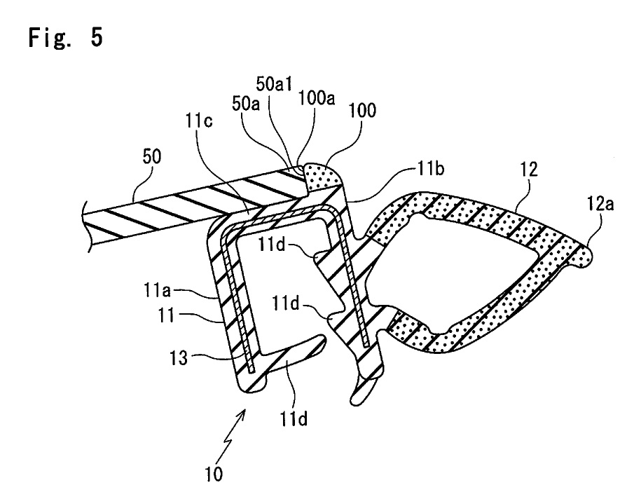

In the present embodiment, the end 50a of the interior member 50 is bent toward the lower side from the upper side. Alternatively, as shown in FIG. 5, the end 50a of the interior member 50 may be linearly extended without bending so that the end surface 50a 1 of the end 50a of the interior member 50 abuts with the inner-cabin side surface 100a of the projection 100.

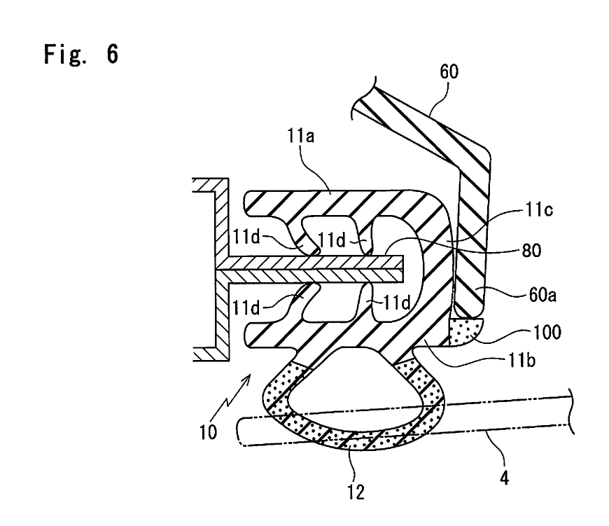

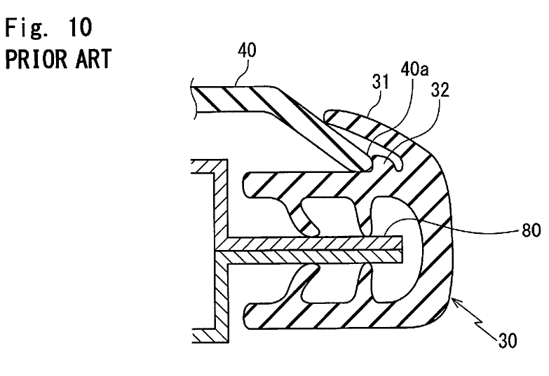

Also, the present embodiment details an example that the sealing structure of the invention is used on the automobile with the back door 1 and the glass hatch 2, which is provided on the back door 1. But, as shown in FIG. 6 and FIG. 9, the present invention is also applicable to a peripheral edge of an opening corresponding to a side door 5 of a hard top vehicle. In this case, the hollow seal member 12 on the outer-cabin side wall 11b of the installation base member 11 is configured to make elastic contact with a side glass 4 and an end 60a of an interior member 60 abuts with the projection 100. Alternatively, the sealing structure is applicable to automobiles with sash doors, which include frames of glasses, and panel doors instead of the hard top vehicles. In this case, the hollow seal member 12 is configured to make elastic contact with the door panel which is not shown, not the side glass 4.

We claim:

1. A sealing structure for an automobile, the automobile being provided with a weather strip and an interior member, the weather strip comprising:
an installation base member configured to operably couple to a flange, the installation base member having a substantially U-shaped cross section including an inner-cabin side wall, an outer-cabin side wall and a connecting wall which connects the side walls and a plurality of holding lips formed on an inner side, the flange being vertically formed along a peripheral edge of an opening corresponding to a door in an internal circumferential direction; and
a seal member configured to make elastic contact with a door panel or a door glass, the seal member being formed on the outer-cabin side wall of the installation base member,
the interior member being provided on an inner-cabin side of the inner-cabin side wall of the installation base member of the weather strip, wherein
an end of said interior member extends toward the connecting wall of the installation base member of said weather strip, and
a projection is formed on an outer circumference of a connecting part between the outer-cabin side wall and the connecting wall of said installation base member, the projection extending in said internal circumferential direction and covering up the end of said interior member from an outer-cabin side, the projection being a lump, and width of the projection in an inner-cabin and an outer-cabin direction being not less than length of the projection.

2. The sealing structure for the automobile as claimed in claim 1, wherein said flange is vertically formed on a back door, and the seal member of said weather strip is configured to make elastic contact with said door glass, the back door having said door glass provided thereon and opening and closing, the door glass being independent from the back door and capable of opening and closing.

3. The sealing structure for the automobile as claimed in claim 2, wherein the end of said interior member is bent toward a lower side from an upper side.

4. The sealing structure for the automobile as claimed in claim 1, wherein said projection comprises sponge material and said installation base member comprises solid material.

5. The sealing structure for the automobile as claimed in claim 2, wherein said projection comprises sponge material and said installation base member comprises solid material.

6. The sealing structure for the automobile as claimed in claim 3, wherein said projection comprises sponge material and said installation base member comprises solid material.
